(19) United States
(12) Patent Application Publication
(10) Pub. No.: US 2015/0042772 A1
(43) Pub. Date: Feb. 12, 2015

(54) DISPLAY APPARATUS AND CONTROL METHOD FOR PROVIDING A 3D IMAGE

(71) Applicant: SAMSUNG ELECTRONICS CO., LTD., Suwon-si (KR)

(72) Inventors: Farid MUKHTAROV, Suwon-si (KR); Ki-hyung KANG, Suwon-si (KR)

(73) Assignee: SAMSUNG ELECTRONICS CO., LTD., Suwon-si (KR)

(21) Appl. No.: 14/453,111

(22) Filed: Aug. 6, 2014

(30) Foreign Application Priority Data
Aug. 6, 2013 (KR) 10-2013-0093190

(51) Int. Cl. H04N 13/00; H04N 13/04

(52) U.S. Cl. CPC H04N 13/0022; H04N 13/0404; H04N 13/0418; H04N 13/0051; H04N 13/0018
USPC 348/58

(57) ABSTRACT

A display apparatus is disclosed. The display apparatus includes an image processor configured to extract a main object from an image frame so as to generate a 2D image frame in a region of the extracted main object in order to generate a 3D image frame in regions other than the main object in the image frame; a display panel configured to alternately output the 2D image frame having a predetermined first resolution and the 3D image frame having a predetermined second resolution; and a controller configured to control a polarization direction of light output from the display panel in synchronization with outputs of the 2D image frame and the 3D image frame. Thus, the display apparatus may provide a high-resolution 3D image and improved depth.

### CROSS-REFERENCE TO RELATED APPLICATIONS

This application claims priority from Korean Patent Application No. 10-2013-0093190, filed on Aug. 6, 2013, in the Korean Intellectual Property Office, the disclosure of which is incorporated herein by reference, in its entirety.

### BACKGROUND

1. Technical Field

The exemplary embodiments relate to a display apparatus and a method of controlling the same. More particularly, the exemplary embodiments relate to a display apparatus that provides a 3D image, and a method of controlling the display apparatus.

2. Description of the Related Art

Along with the development of electronic technology, various types of display apparatuses have been developed. As the type and display method of display apparatuses have been diversified, the type of content which correspond thereto has also diversified. In recent years, stereoscopic display systems capable of viewing 3D contents have been developed. The stereoscopic display system can be roughly classified into a glass-free type system capable of viewing without using glasses and a glass type system capable of viewing using glasses.

Representative types of a glass-free type system include a parallax barrier type system, a lenticular lens type system, and a directional back light (BLU) type system. In a glass-free type system, an image having binocular parallax has to be input to two eyes of a human. Thus, the glass-free type system displays images having a parallax for each pixel line or for each certain region, and a user only views images that are displayed in some pixel lines or some regions. That is, in the glass-free type system, images having n pieces of parallax in one frame have to be displayed in order to display a 3D image based on n viewpoints, and a user only views one of the images. As a result, the user views an image having a resolution of 1/n. In addition, there is a disadvantage in that the glass-free type system has a stereo effect which is inferior to that of the glass type system.

Therefore, in the glass-free type system, the need for a technique capable of perceiving a high-resolution 3D image and an improved depth has increased.

### SUMMARY

The exemplary embodiments have been developed in view of such situations, and an object thereof is to provide a display apparatus which provides a high-resolution 3D image and is capable of providing improved depth and a method of controlling the display apparatus.

According to an aspect of the exemplary embodiments, a display apparatus is provided which includes an image processor configured to extract a main object from an image frame to generate a 2D image frame in a region of the extracted main object, and to generate a 3D image frame in regions other than the main object in the image frame; a display panel configured to alternately output the 2D image frame having a predetermined first resolution and the 3D image frame having a predetermined second resolution; and a controller configured to control a direction of polarization of light output from the display panel, in synchronization with outputs of the 2D image frame and the 3D image frame.

The display panel may include a panel module; and a lens module configured to refract light emitted from the panel or to make the light advance straight ahead. The lens may include: a micro lens having an optical isotropic characteristic or an optical anisotropic characteristic, depending on a direction of polarization; and a polarization switch configured to be capable of switching the direction of polarization.

The lens module may have an optical isotropic characteristic in response to light being incident in a direction perpendicular to a direction of orientation direction of the panel module, and has an optical isotropic characteristic in response to light being incident to a direction parallel to the direction of orientation of the panel module.

The controller may control the panel module, in response to the 2D image frame being output, in order to output light in a direction perpendicular to the direction of orientation of the panel so as to have an optical isotropic characteristic, and controls the panel module, in response to the 3D image frame being output, in order to output light in a direction parallel to the direction of orientation of the panel module so as to have an optical isotropic characteristic.

The image processor may extract an object as a main object, which is closest to a user's viewpoint of objects within the image frame.

The image processor may extract an object selected as a main object by a user's input.

The image processor may extract as a main object a human face or a body in objects within the image frame.

The image processor may extract text information as a main object within the image frame.

According to another aspect of the exemplary embodiments, a method of controlling a display apparatus is provided, the method including: extracting a main object from an image frame in order to generate a 2D image frame in a region of the extracted main object and to generate a 3D image frame in regions other than the main object in the image frame; and alternately outputting the 2D image frame having a predetermined first resolution and the 3D image frame having a predetermined second resolution. The outputting of the 2D image frame and the 3D image frame includes controlling a direction of polarization of light output from the display panel, in synchronization with outputs of the 2D image frame and the 3D image frame.

The outputting of the 2D image frame and the 3D image frame may include: controlling the panel module in response to the 2D image frame being output, in order to output light in a direction perpendicular to a direction of orientation of the panel module so as to have an optical isotropic characteristic; and controlling the panel module to output light in a direction parallel to the direction of orientation of the panel module to have an optical isotropic characteristic in response to the 3D image frame being output.

The generating of the 2D image frame may include extracting an object, as a main object, which is closest to a user's viewpoint of objects within the image frame.

The generating of the 2D image frame may include extracting an object selected as a main object by a user's input.

The generating of the 2D image frame may include extracting a human face or a body as a main object of objects within the image frame.

The generating of the 2D image frame may include extracting as a main object text information within the image frame.

Additional and/or other aspects and advantages of the exemplary embodiments will be set forth in part in the description which follows and, in part, will be obvious from the description, or may be learned by practice of the exemplary embodiments.

According to various exemplary embodiments, a display apparatus can provide a high-resolution 3D image and improved depth.

An aspect of an exemplary embodiment may provide a display apparatus including: a display panel configured to alternately output the 2D image frame having a predetermined first resolution and the 3D image frame having a predetermined second resolution; an image processor configured to extract a main object from an image frame so as to generate a 2D image frame in a region of the extracted main object and to generate a 3D image frame in regions other than the main object in the image frame; and a controller configured to control a direction of polarization of light output from a display panel in synchronization with outputs of the 2D image frame and the 3D image frame, wherein the controller is configured to control the panel module, in response to the 2D image frame being output, in order to output light in a direction perpendicular to the orientation direction of the panel module so as to have an optical isotropic characteristic, and controls the panel module to output light in a direction parallel to the orientation direction of the panel module so as to have an optical isotropic characteristic in response to the 3D image frame being output.

The image processor may be configured to extract a human face or a body as a main object from among objects within the image frame.

In addition, the image processor may be configured to extract text information as a main object within the image frame.

### BRIEF DESCRIPTION OF THE DRAWING FIGURES

The above and/or other aspects will be more apparent by describing certain exemplary embodiments with reference to the accompanying drawings, in which:

FIG. 1 is a block diagram of a display apparatus according to an exemplary embodiment;

FIG. 2 is a block diagram of a display apparatus according to another exemplary embodiment;

FIG. 3 is a diagram which illustrates a structure of a display panel according to an exemplary embodiment;

FIGS. 4A and 4B are diagrams which illustrate an operation of the display panel according to an exemplary embodiment;

FIGS. 5A and 5B are diagrams which illustrate a 3D image;

FIG. 6 is a diagram which illustrate a relationship between convergence and accommodation;

FIGS. 7A and 7B are diagrams which illustrate a 2D image frame and a 3D image frame according to an exemplary embodiment;

FIGS. 8A, 8B-1, and 8B-2 are diagrams which illustrate a process of extracting a human as a main object, according to an exemplary embodiment;

FIG. 9 is a diagram which illustrates a process of alternately displaying a 2D image frame and a 3D image frame, according to an exemplary embodiment; and

FIG. 10 is a flow chart which illustrates a method of controlling the display apparatus according to an exemplary embodiment.

### DETAILED DESCRIPTION OF THE EXEMPLARY EMBODIMENTS

Reference will now be made in detail to exemplary embodiments, examples of which are illustrated in the accompanying drawings. Also, while describing the exemplary embodiments, detailed descriptions regarding well-known functions or configurations that may diminish the clarity of the points of the exemplary embodiments are omitted. Terms or words used herein shall not be restricted to their common or dictionary meanings, and have meanings which correspond to technical aspects of the exemplary embodiments so as to most suitably express the exemplary embodiments.

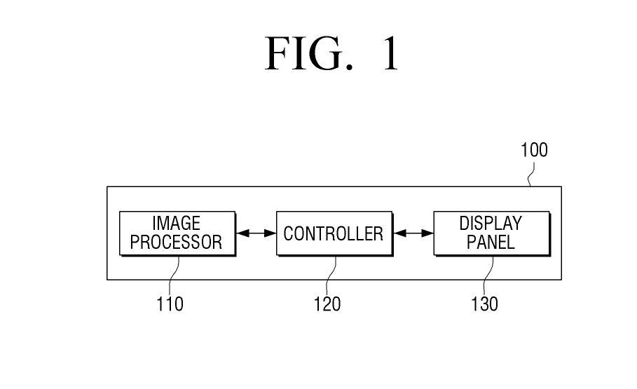

FIG. 1 is a block diagram of a display apparatus according to an exemplary embodiment.

Referring to FIG. 1, a display apparatus 100 includes an image processor 110, a controller 120 and a display panel 130.

The display apparatus 100 may be configured as a TV, a tablet PC, a portable multimedia player (PMP), a PDA, a smart phone, a digital photo frame, a game machine, a kiosk, an electric lighting board, or an electronic book, but is not limited thereto.

The image processor 110 extracts a main object from an image frame to generate a 2D image frame in a region of the extracted main object. The 2D image frame refers to a general image frame including only a main object.

The image processor 110 generates a 3D image frame in regions other than the main object in the image frame. For example, one 3D image frame is divided into a plurality of columns which include a plurality of pixels. Images having a different viewpoint for each of the columns are disposed. In response to the plurality of columns being divided into four columns, one 3D image frame is configured in such a manner that a plurality of images 1, 2, 3 and 4 having different viewpoints and pieces of parallax are sequentially and repeatedly disposed. The images 1, 2, 3, and 4 are refracted and output through a lens module included in the display panel 130. A user at a specific position receives a plurality of images having different viewpoints through the right and left eyes, and thus the user may perceive a stereo effect.

The 3D image frame of the exemplary embodiments is similar to a general 3D image frame that is generated by a general glass-free 3D display apparatus. The 3D image frame is generated in regions other than a main object, with respect to one image frame.

The controller 120 controls the display panel 130 to alternately display the 2D image frame and the 3D image frame, which are generated by the image processor 110. The controller 120 outputs the 2D image frame at a predetermined first resolution, and outputs the 3D image frame at a predetermined second resolution. The predetermined first resolution may be higher than the second resolution. For example, the predetermined first resolution may be a maximum resolution that is supportable by the display apparatus 100. The predetermined second resolution may be a resolution that is appropriately set in order to smoothly output the 3D image frame. The glass-free 3D display apparatus may combine a plurality of images having n viewpoints with respect to one 3D image frame and output the combined images. Thus, even though the total resolution of the 3D image frame is equal to the resolution of the 2D image frame, a user may perceive the 3D image frame having a resolution of 1/n.

In addition, the controller 120 controls a refractive index of the display panel 130 in synchronization with outputs of the 2D image frame and the 3D image frame. The control of the refractive index may be performed by controlling a direction of light that is output from the display panel 130, or may be performed by adjusting a refractive index of the lens module.

The display panel 130 alternately outputs the 2D image frame and the 3D image frame under the control of the controller 120. A specific process thereof will be described below.

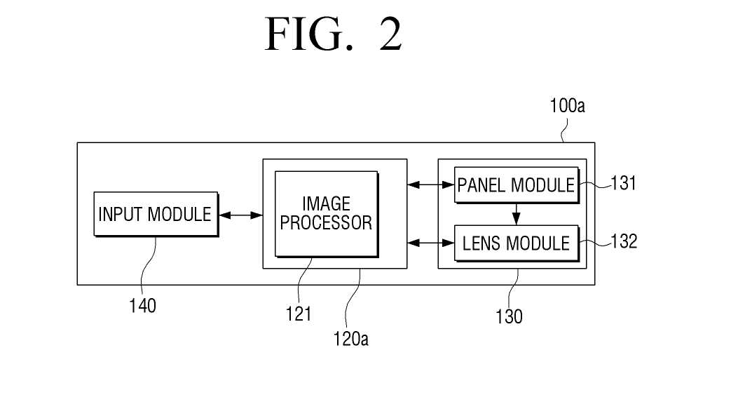

FIG. 2 is a block diagram of a display apparatus according to another exemplary embodiment. Referring to FIG. 2, a display apparatus 100a may include an input module 140, a controller 120a, and a display panel 130.

The input module 140 may receive an image signal. For example, the input module 140 may include a broadcast signal reception module (not shown) to receive a broadcast signal that is transmitted from a broadcast transmission apparatus. Alternatively, the input module 140 may include a wireless LAN module (not shown) or a connector (not shown) to receive an image signal from an external apparatus in a wired or wireless manner. In addition, the input module 140 may receive a user command to select a main object in one image frame. In this case, the input module 140 may be configured as a keyboard, a mouse, a keypad, or the like. In some cases, the input module 140 may be configured as a remote controller reception module for receiving a user command transmitted by a remote controller, a camera for receiving a user gesture, a microphone for receiving a user's voice, or the like.

The display panel 130 may include a panel module 131 and a lens module 132. The panel device 131 includes a plurality of pixel lines, and displays an image frame in the plurality of pixel lines. Thus the panel module 131 may provide a 3D image to a user. The term “pixel line” as used herein means a line in which a plurality of pixels are arranged. The pixel line may be formed vertically, but the exemplary embodiments are not limited thereto.

The panel module 131 may drive pixels in each of the pixel lines of the panel module 131 in response to pixel values of the pixels constituting the image frame to be displayed. For example, the panel module 131 may be configured as various panels such as a liquid crystal display (LCD) panel, a plasma display panel (PDP), an organic light emitting diode (OLED), a vacuum fluorescent display (VFD), a field emission display (FED), or an electro luminescence display (ELD).

The lens module 132 may refract light emitted from the panel module 131 or may make the light advance straight ahead. For example, when the light emitted from the display panel 130 is incident in a direction perpendicular to an orientation direction of the panel module 131, the light may be advanced straight ahead because the lens module 132 has an optical isotropic characteristic. When the light emitted from the display panel 130 is incident in a direction parallel to the orientation direction of the panel module 131, the light may be refracted because the lens module 132 has an optical isotropic characteristic. As another example, the lens module 132 may control the refraction of light passing through the lens module 132 by its optical characteristic varying depending on whether an electric field is applied thereto by an electrode. Specifically, in response to the display apparatus 100a outputting the 2D image frame, the lens module 132 may transmit the light emitted from the panel module 131 without any change to be provided to a user. In response to the display apparatus 100a outputting the 3D image frame, the panel module 131 refracts the light emitted from the panel module 131 so that two regions having parallax which are included in the 3D image frame are incident on the right and left eyes of a user.

The controller 120a may include an image processor 121. Although FIG. 1 illustrates an example in which the image processor and the controller are separated from each other, the image processor 121 may be configured to be included in the controller 120a. A function of the image processor 121 has been described above with reference to FIG. 1, and thus a description thereof will be omitted herein.

The controller 120a may control the panel module 131 and the lens module 132 which are included in the display panel 130. The controller 120a controls the panel module 131 so as to alternately display the 2D image frame and the 3D image frame.

As an example, when the 2D image frame is output, the controller 120a may control the panel module 131 to output light in a direction perpendicular to an orientation direction of the panel module 131 to thereby have an optical isotropic characteristic. When the 3D image frame is output, the controller 120a may control the panel module 131 to output light in a direction parallel to the orientation direction of the panel module 131 to thereby exhibit an optical isotropic characteristic.

As another example, in response to the panel module 131 outputting the 2D image frame, the controller 120a does not apply an electric field to an electrode included in the display panel 130 so that a liquid crystal layer and a medium layer which are included in the display panel 130 may have the same refractive index. Thus, since the lens module 132 of the display panel 130 has the same refractive index, the lens module 132 may transmit light in the same manner as a general display apparatus. In response to the panel module 131 outputting the 3D image frame, the controller 120a applies an electric field to an electrode included in the display panel 130 so that the liquid crystal layer and the medium layer which are included in the display panel 130 may have different refractive indexes. Accordingly, the lens module 132 of the display panel 130 may transmit light refracted based on a predetermined refractive index.

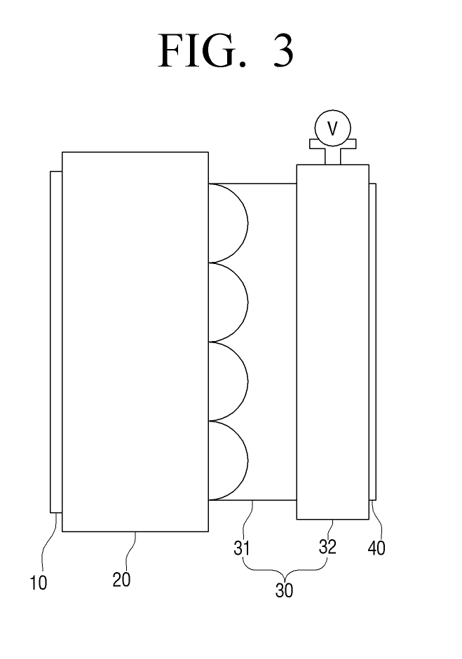

FIG. 3 is a diagram which illustrates a structure of a display panel, according to an exemplary embodiment. Referring to FIG. 3, the display panel includes an input polarizing plate 10, a panel module 20, a lens module 30, and an output polarizing plate 40.

The input polarizing plate 10 and the output polarizing plate 40 may adjust a direction of polarization of light. That is, the input polarizing plate 10 and the output polarizing plate 40 may have a fixed polarization characteristic and may only output light in a specific direction of polarization. Alternatively, the input polarizing plate 10 and the output polarizing plate 40 may change a polarization characteristic, in response to an external input such as the supply of power, so as to output light in a polarization direction which corresponds to the changed characteristic.

The panel module 20 includes a plurality of pixel lines, and may display an image frame in the plurality of pixel lines so as to provide a 2D image or a 3D image to a user. The term “pixel line” as used herein refers to a line in which a plurality of pixels are arranged. The pixel line may be formed vertically, but the exemplary embodiments are is not limited thereto.

The panel module 20 may drive pixels in each of the pixel lines of the panel module 20 in response to pixel values of the pixels which contribute the image frame to be displayed. For this, the panel module 20 may include a panel driving unit (not shown) for driving the pixels under the control of the controller.

In particular, when the display apparatus operates in a 3D mode, the panel module 20 may alternately provide a left eye image and a right eye image of a 3D image in at least one pixel module and may display the left eye image and the right eye image.

Meanwhile, the panel module 20 may be configured as various panel apparatuses such as an LCD, a PDP, or an OLED.

The lens module 30 may refract light emitted from the panel module 20 or may make the light advance straight ahead. The lens module 30 may include a micro lens 31 and a polarization switch 32. The micro lens 31 may have an optical isotropic characteristic or an optical anisotropic characteristic, depending on a direction of polarization. The polarization switch 32 may switch a direction of polarization.

Hereinafter, a specific description will be made of a process of operating the display panel in response to the display apparatus outputting a 2D image frame or a 3D image frame.

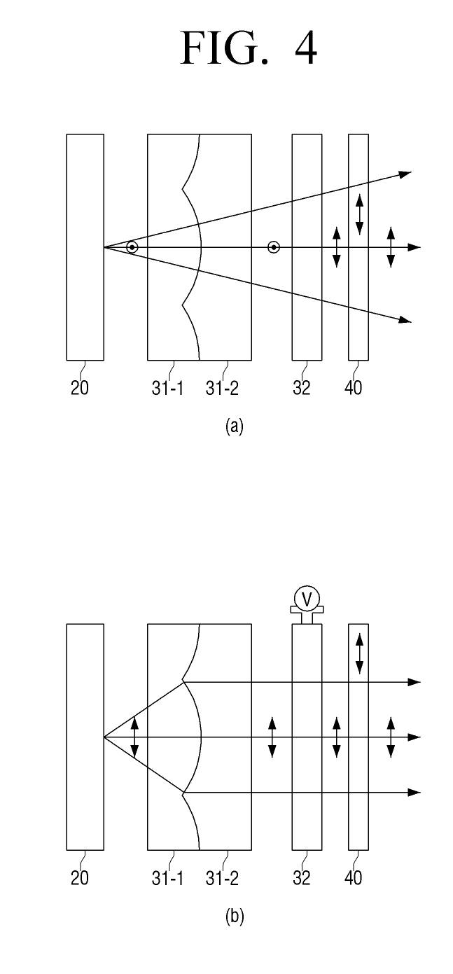

FIGS. 4A and 4B are diagrams which illustrate an operation of the display panel according to an exemplary embodiment. FIG. 4A is a diagram which illustrates an operation of the display panel when the display apparatus outputs a 2D image frame. FIG. 4B is a diagram which illustrates an operation of the display panel in response to the display apparatus outputting a 3D image frame.

Referring to FIG. 4A, the micro lens 31 includes a lenticular surface relief structure 31-1 containing a birefringent material and a layer 31-2 containing an isotropic material. The refractive index of the isotropic material is generally set to be equal to one of the refractive indexes of the birefringent material. An array of the micro lens 31 containing the birefringent material is arranged in image pixel column pairs of the panel module 20.

In response to the display panel outputting the 2D image frame, the controller controls a polarization direction of light, which is to be output, to be perpendicular to an orientation direction of the panel module 20. In response to the light being incident in a direction perpendicular to the orientation direction of the panel module 20, the micro lens 31 may not perceive a difference in refractive index between the lenticular surface relief structure 31-1 and the layer 31-2 containing an isotropic material. Accordingly, the incidence light passes through the micro lens 31 without being refracted.

The polarization switch 32 rotates a polarization state of the light output from the micro lens 31 at 90 degrees. The light rotated at 90 degrees is perceived by a user through the output polarizing plate 40. That is, since the micro lens 31 does not perform an optical function, the user may view all the pixels of the display panel and may perceive an output image at a full resolution. In response to the polarization switch 32 neglecting Fresnel reflection and loss, the brightness of the image is substantially the same as basic display brightness.

Referring to FIG. 4B, a process of the display panel outputting a 3D image frame is illustrated. The controller controls a polarization direction of light, which is to be output, to be parallel to a direction of orientation of the panel module 20. In response to light being incident on the micro lens 31 in a direction parallel to the orientation direction of the panel module 20, a difference in refractive index occurs between the lenticular surface relief structure 31-1 and the layer 31-2 containing an isotropic material. Accordingly, the incidence light is refracted when passing through the micro lens 31. That is, the micro lens 31 operates as a lens having a limited focal length. The light output from the micro lens 31 passes through the polarization switch 32 having a voltage applied thereto so as not to rotate the polarization state, and the polarization state is maintained. The light having passed through the polarization switch 32 is perceived by a user through the output polarizing plate 40.

Two eyes of the user perceive light output from another pixel column by the refraction at the micro lens 31. In response to images pairs having parallax being output from each pixel column, the user combines the image pairs with an image output from another pixel column, and thus the user may perceive a stereo effect.

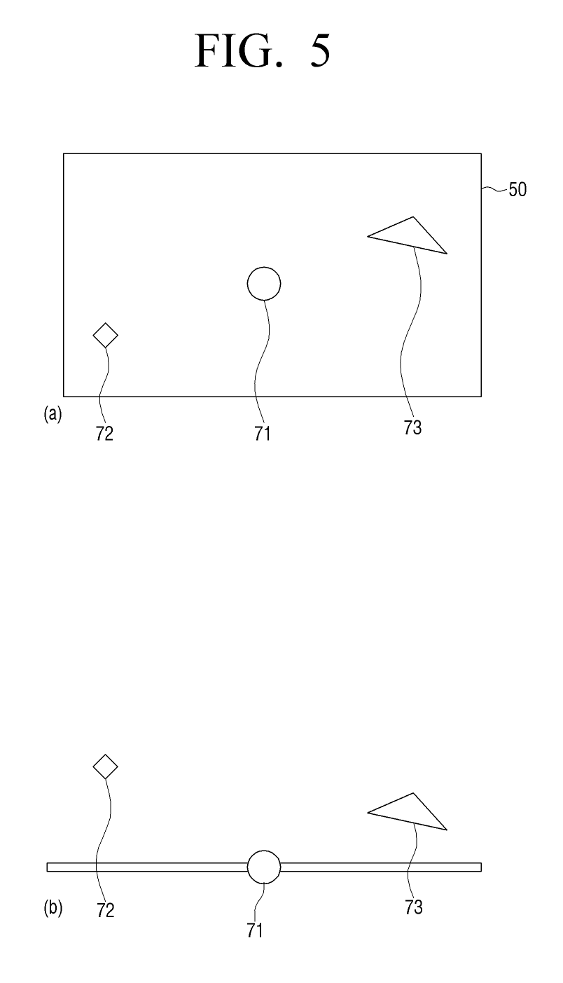

FIGS. 5A and 5B are diagrams which illustrate a 3D image.

FIG. 5A is a front view of a screen of a display panel 50 displaying a 3D image, which is viewed by a user. The display panel 50 displays a main object 71 and sub-objects 72 and 73. For example, the main object 71 may be an object closest to a user's viewpoint. Alternatively, the main object 71 may be an object selected by a user's input. Alternatively, a human's face or body may be set as the main object 71 in one image frame. Alternatively, text information within the image frame may be set as the main object 71. In FIG. 5A, the object closest to the user's viewpoint is defined as the main object 71.

FIG. 5B illustrates the display panel 50 which displays a plurality of objects on a depth basis. The plurality of objects may be perceived as being located on the surface of the display panel 50 depending on a depth, or may be perceived as having various depths, depending on a depth. That is, the main object 71 may be perceived as being located on the surface of the display panel 50, and the sub-objects 72 and 73 may be perceived as being located behind the main object 71.

In this manner, objects included in the 3D image are perceived by a user as being located at different places depending on depth information. Hereinafter, a characteristic of a user viewing a 3D image will be described.

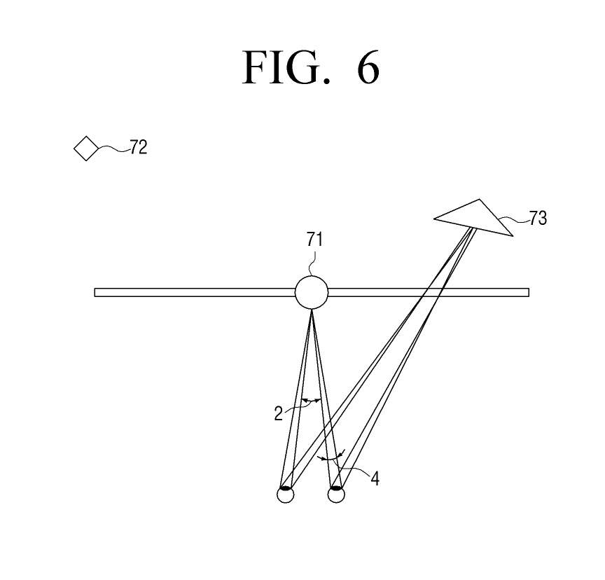

FIG. 6 is a diagram which illustrates a relationship between convergence and accommodation. FIG. 6 illustrates a state where a user is viewing the main object 71 and the sub-object 73.

A user views an object through processes of convergence 2 and accommodation 4 of two eyes. The term “convergence 2 of two eyes” as used herein means that the two eyes converge when viewing one object. That is, pupils rotate so as to adjust an angle between an object and two eyes in order to focus a human's eyes on an approaching or receding object. Since human's eyes are separated from each other at a distance of approximately 6 to 7 cm, binocular parallax occurs, and thus a stereo effect is produced by the binocular parallax. The term “accommodation 4” as used herein means a variation in focal length of a crystalline lens depending on a distance between the eye and an object when staring at a specific portion of the object. A human brain calculates a distance to an object by using the focal length, and may perceive a stereo effect by perceiving a difference in distance between a plurality of objects.

In response to a user viewing a 3D image, the user focuses their eyes on a specific object. For example, the specific object may be an object located at a relatively short distance from the user, a relatively large object, a relatively clear object, or a relatively meaningful object, such as a human. That is, in the exemplary embodiments, the main object 71 is equivalent to the above-mentioned specific object. In response to a user focusing their eyes on the main object 71 and view the main object 71, the user may not relatively focus the eyes on the sub-object 73, and thus the main object 71 is displayed relatively blurry. Conversely, in response to the main object 71 being displayed clear and the sub-object 73 being displayed in a blurry manner, the user may perceive a greater difference in depth between objects, and thus the user may perceive a greater stereo effect. In addition, in response to the main object 71 on which the user focuses the eyes being displayed clear; the user may perceive an image as having a higher resolution. Thus, in the exemplary embodiments, the main object 71 is extracted to generate a 2D image frame, and a 3D image frame is generated in regions other than the main object 71, and then the 2D image frame and the 3D image frame are alternately displayed. The display apparatus outputs a 2D image frame having a resolution higher than that of a 3D image frame. In this manner, the display apparatus may provide the user with a high-resolution 3D image and an improved stereo effect.

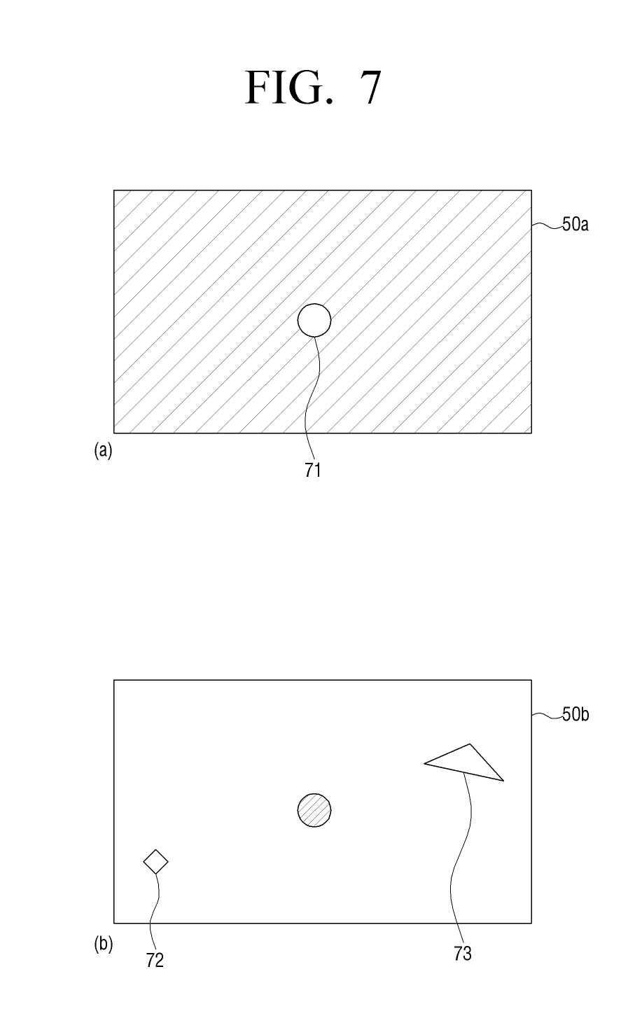

FIGS. 7A and 7B are diagrams which illustrate a 2D image frame and a 3D image frame according to an exemplary embodiment.

Referring to FIG. 7A, a 2D image frame 50a is illustrated. The display apparatus extracts a main object 71 from the 2D image frame 50a. For example, the main object 71 may be an object closest to a user's viewpoint, an object selected by a user's input, or a human's face or body in one image frame or text information. The display apparatus generates the 2D image frame 50a including only the main object 71. The 2D image frame may have a resolution higher than that of a 3D image frame. For example, the 2D image frame 50a may have a maximum resolution that is supportable by the display apparatus.

Referring to FIG. 7B, a 3D image frame 50b is illustrated. The display apparatus generates the 3D image frame 50b in regions other than the main object 71 in the image frame. That is, the 3D image frame 50b includes sub-objects 72 and 73. The sub-objects 72 and 73 may be background images. In the 3D image frame 50b, a region where the main object 71 is located may be marked in black. The 3D image frame 50b may be an image frame that is the same as an image frame provided in a general glass-free 3D display apparatus, except for the main object 71.

FIGS. 8A, 8B-1, and 8B-2 are diagrams which illustrate a process of extracting a human as a main object, according to an exemplary embodiment.

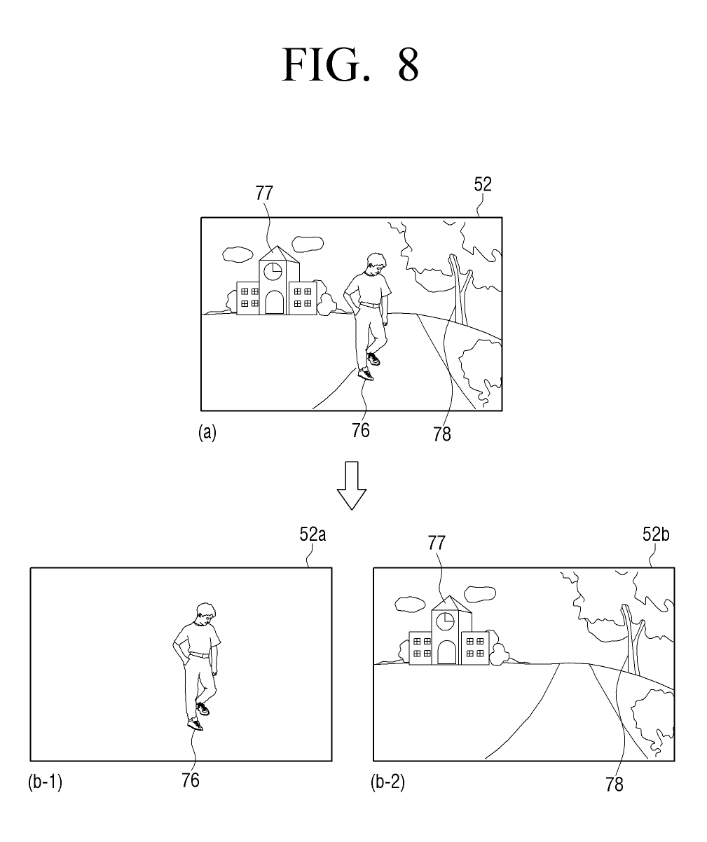

Referring to FIG. 8A, one image frame 52 includes a human 76, a building 77 and a tree 78. In FIG. 8A, since the human 76 is a main object, the display apparatus may extract the region of the human 76 in order to generate a 2D image frame and a 3D image frame.

Referring to FIG. 8B-1, a 2D image frame 52a is illustrated. As described above, the display apparatus may generate the 2D image frame 52a including only the human 76, which is the main object. In the 2D image frame 52a, regions other than the human 76 may be marked in black.

Referring to FIG. 8B-2, a 3D image frame 52b is illustrated. The display apparatus may generate the 3D image frame 52b that is the same as a general 3D frame by using only regions other than the human 76 which is the main object. In the 3D image frame 52b, the region of the human may be marked in black, i.e., not illustrated.

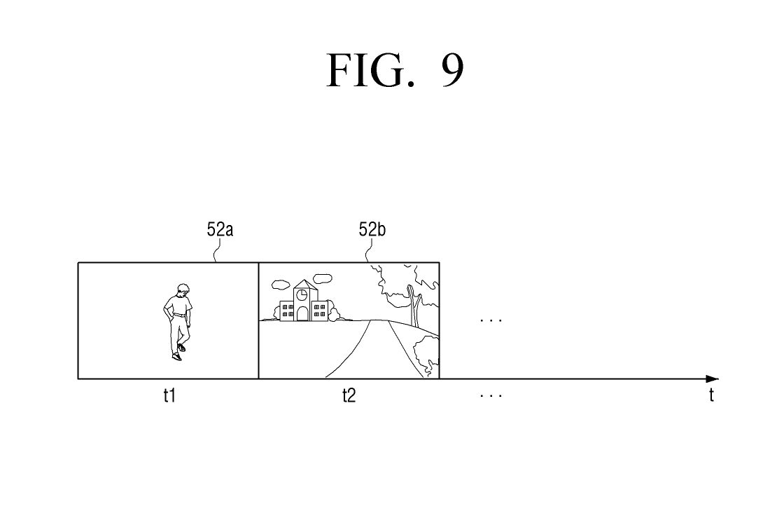

FIG. 9 is a diagram which illustrates a process of alternately displaying a 2D image frame and a 3D image frame, according to an exemplary embodiment.

The display apparatus alternately displays the 2D image frame 52a and the 3D image frame 52b. At this time, the display apparatus may apply an electric field to a liquid crystal layer so that light emitted from the panel module may be or may not be refracted.

For example, the display apparatus may control an electric field so as to not be applied to an electrode of the liquid crystal layer, while displaying the 2D image frame 52a at the point of t1. In this case, the liquid crystal layer and the medium layer may have the same refractive index. Accordingly, the 2D image frame 52a with high-resolution may be incident on two eyes of a user without being refracted.

The display apparatus may control an electric field so as not to be applied to an electrode of the liquid crystal layer, while displaying the 3D image frame 52b at the point of t2. In this case, the liquid crystal layer and the medium layer may have different refractive indexes. Accordingly, the 3D image frame 52b is refracted, and two regions having different pieces of parallax may be respectively incident on the right and left eyes of the user.

In some cases, the display apparatus may add a black insertion image frame between the 2D image frame 52a and the 3D image frame 52b in order to prevent the occurrence of crosstalk. In this case, the display apparatus may alternately output the 2D image frame 52a, the insertion image frame, the 3D image frame 52b, and the insertion image frame in this order.

Such a process is repeatedly performed so that the user may view the 2D image frame and 3D image frame, which have high-resolution, and may perceive a high-resolution 3D image and an improved stereo effect.

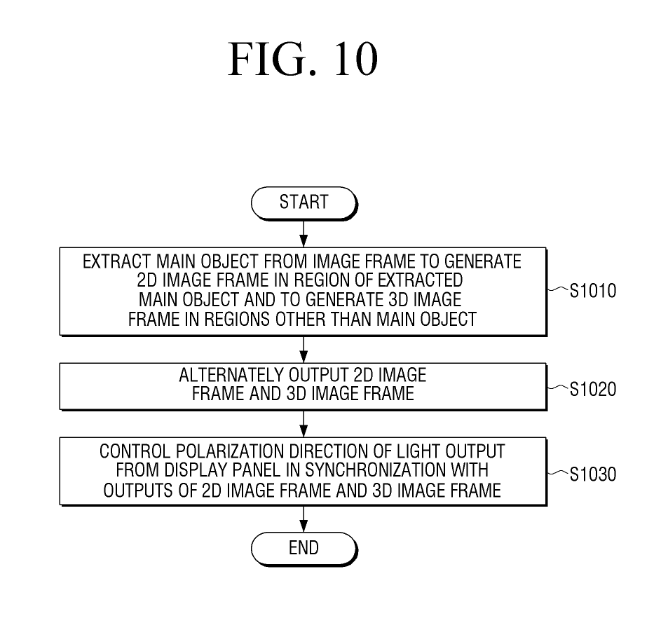

FIG. 10 is a flow chart which illustrates a method of controlling the display apparatus, according to an exemplary embodiment.

Referring to FIG. 10, the display apparatus extracts a main object from an image frame to generate a 2D image frame in a region of the extracted main object and to generate a 3D image frame in regions other than the main object (operation S1010). In order to generate the 2D image frame, the display apparatus may extract, as main objects, an object closest to a user's viewpoint, an object selected by a user's input, or a human's face or body of an object in one image frame or text information within the image frame.

The display apparatus alternately outputs the 2D image frame and the 3D image frame (operation S1020). The 2D image frame may be output at a high resolution (for example, a maximum resolution that is supportable by the display apparatus).

At this time, the display apparatus controls a direction of polarization of light output from the display panel, in synchronization with outputs of the 2D image frame and the 3D image frame (operation S1030). As an example, in response to the display apparatus outputting the 2D image frame, the display apparatus may control the panel module to output light in a direction perpendicular to an orientation direction of the panel module to thereby have an optical isotropic characteristic. In response to the display apparatus outputting the 3D image frame, the display apparatus may control the panel module to output light in a direction parallel to the orientation direction of the panel module to thereby have an optical isotropic characteristic.

As another example, in response to the display apparatus outputting the 2D image frame, the display apparatus does not apply an electric field to an electrode included in the display panel so as to control the liquid crystal layer and the medium layer which are included in the display panel to have the same refractive index. In response to the display apparatus outputting the 3D image frame, the display apparatus applies an electric field to an electrode included in the display panel so as to control the liquid crystal layer and the medium layer which are included in the display panel in order to have different refractive indexes.

The method of controlling the display apparatus according to the various exemplary embodiments described above may be implemented as a computer implemented program and provided to the display apparatus.

For example, a non-transitory computer readable storage medium may be provided which stores a program for executing extracting a main object from an image frame to generate a 2D image frame in a region of the extracted main object and to generate a 3D image frame in regions other than the main object in the image frame; and alternately outputting the 2D image frame having a predetermined first resolution and the 3D image frame having a predetermined second resolution, wherein the outputting of the 2D image frame and the 3D image frame includes controlling a polarization direction of light output from a display panel in synchronization with outputs of the 2D image frame and the 3D image frame.

The term “non-transitory readable medium” as used herein means a medium that semipermanently stores data and is readable by a device, rather than a medium such as a register, a cache, or a memory which stores data for a short period of time. Specifically, the non-transitory readable medium may be, a CD, a DVD, a hard disk, a Blu-ray Disc™, a USB, a memory card, a ROM, or the like.

The foregoing exemplary embodiments and advantages are merely exemplary and are not to be construed as limiting the disclosure. The present teaching may be readily applied to other types of apparatuses. Also, the description of the exemplary embodiments of the present invention is intended to be illustrative, and not to limit the scope of the claims, and many alternatives, modifications, and variations will be apparent to those skilled in the art.

What is claimed is:

1. A display apparatus comprising:
an image processor configured to extract a main object from an image frame so as to generate a 2D image frame in a region of the extracted main object and to generate a 3D image frame in regions other than the main object in the image frame;
a display panel configured to alternately output the 2D image frame having a predetermined first resolution and the 3D image frame having a predetermined second resolution; and
a controller configured to control a direction of polarization of light output from the display panel in synchronization with outputs of the 2D image frame and the 3D image frame.

2. The display apparatus of claim 1,
wherein the display panel comprises:
a panel module; and
a lens module configured to refract light emitted from the panel module or to make the light advance straight ahead, and
wherein the lens module comprises:
a micro lens having an optical isotropic characteristic or an optical anisotropic characteristic depending on a direction of polarization; and
a polarization switch configured to be capable of switching the direction of polarization.

3. The display apparatus of claim 2, wherein the lens unit has an optical isotropic characteristic in response to light being incident in a direction perpendicular to a direction of orientation of the panel module, and has an optical isotropic characteristic in response to light being incident in a direction parallel to the direction of orientation of the panel module.

4. The display apparatus of claim 3, wherein the controller is configured to control the panel module, in response to the 2D image frame being output, in order to output light in a direction perpendicular to the orientation direction of the panel module so as to have an optical isotropic characteristic, and controls the panel module to output light in a direction parallel to the orientation direction of the panel module so as to have an optical isotropic characteristic in response to the 3D image frame being output.

5. The display apparatus of claim 1, wherein the image processor extracts an object, as a main object, which is closest to a user's viewpoint from among objects within the image frame.

6. The display apparatus of claim 1, wherein the image processor extracts an object selected by a user's input as a main object.

7. The display apparatus of claim 1, wherein the image processor extracts a human face or a body as a main object from among objects within the image frame.

8. The display apparatus of claim 1, wherein the image processor extracts text information as a main object within the image frame.

9. A method of controlling a display apparatus, the method comprising:
extracting a main object from an image frame to generate a 2D image frame in a region of the extracted main object and to generate a 3D image frame in regions other than the region of the extracted main object in the image frame; and
alternately outputting the generated 2D image frame having a predetermined first resolution and the generated 3D image frame having a predetermined second resolution,
wherein the outputting of the 2D image frame and the 3D image frame comprises controlling a direction of polarization of light output from the display panel in synchronization with outputs of the generated 2D image frame and the generated 3D image frame.

10. The method of claim 9, wherein the outputting of the generated 2D image frame and the generated 3D image frame comprises:
controlling the panel module, to output light in a direction perpendicular to an orientation direction of the panel module so as to have an optical isotropic characteristic in response to the generated 2D image frame being output; and
controlling the panel module, to output light in a direction parallel to the direction of orientation of the panel module so as to have an optical isotropic characteristic in response to the generated 3D image frame being output.

11. The method of claim 9, wherein the generating of the 2D image frame comprises extracting an object, as a main object, which is closest to a user's viewpoint from among objects within the image frame.

12. The method of claim 9, wherein the generating of the 2D image frame comprises extracting an object selected by a user's input as a main object.

13. The method of claim 9, wherein the generating of the 2D image frame comprises extracting a human face or a body from objects within the image frame as a main object.

14. The method of claim 9, wherein the generating of the 2D image frame comprises extracting text information as a main object within the image frame.

15. A display apparatus comprising:
a display panel configured to alternately output the 2D image frame having a predetermined first resolution and the 3D image frame having a predetermined second resolution;
an image processor configured to extract a main object from an image frame so as to generate a 2D image frame in a region of the extracted main object and to generate a 3D image frame in regions other than the main object in the image frame; and
a controller configured to control a direction of polarization of light output from a display panel in synchronization with outputs of the 2D image frame and the 3D image frame,
wherein the controller is configured to control the panel module, in response to the 2D image frame being output, in order to output light in a direction perpendicular to the orientation direction of the panel module so as to have an optical isotropic characteristic, and controls the panel module to output light in a direction parallel to the orientation direction of the panel module so as to have an optical isotropic characteristic in response to the 3D image frame being output.

16. The display apparatus of claim 15, wherein the image processor is configured to extract a human face or a body as a main object from among objects within the image frame.

17. The display apparatus of claim 15, wherein the image processor is configured to extract text information as a main object within the image frame.
